(19) United States
(12) Patent Application Publication
(10) Pub. No.: US 2009/0081101 A1
(43) Pub. Date: Mar. 26, 2009

(54) YTTRIA-STABILIZED ZIRCONIA SINTERED BODY AND METHOD FOR PRODUCING THE SAME

(75) Inventors: Hiroshi SUGII, Osaka-shi (JP); Ken YAMAGUCHI, Osaka-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: DAIICHI KIGENSO KAGAKU KOGYO CO., LTD., Osaka (JP); DENSO CORPORATION, Kariya-shi (JP)

(21) Appl. No.: 11/858,499

(22) Filed: Sep. 20, 2007

(51) Int. Cl. C01F 17/00

(52) U.S. Cl. 423/263

(57) ABSTRACT

To provide an yttria-stabilized zirconia sintered body having high hydrothermal deterioration resistance in addition to excellent thermal shock resistance.

Methods for Achieving the Object

A stabilized zirconia sintered body comprising yttria, wherein
1) the sintered body is substantially composed of monoclinic crystals and cubic crystals; and
2) an increase of the monoclinic crystals included in the sintered body is 10% by volume or less after the body is subjected to hydrothermal deterioration test for 5 hours, at 180° C., at 10 atmospheres.

### TECHNICAL FIELD

The present invention relates to an yttria-stabilized zirconia sintered body and a method for producing the same.

### BACKGROUND OF THE INVENTION

An yttria-stabilized zirconia sintered body, in particular, an yttria-stabilized zirconia sintered body comprising monoclinic and cubic crystals has excellent properties such as high vibration resistance, high resistance to rapid heating and high quenching resistance, etc., in addition to good electrical properties. Therefore, it is widely used as an oxygen sensor that detects the oxygen levels in exhaust gases from an automobile engine.

Known prior art relating to an yttria-stabilized zirconia sintered body are disclosed in the following publications.

Japanese Examined Patent Application Publication No. 59-47258 discloses a solid electrolyte oxygen sensor comprising ZrO₂—Y₂O₃ based ceramics, wherein the ceramic is composed of a mixed phase of a first ZrO₂ phase, which is in cubic form at room temperature, and a second ZrO₂ phase, which is in monoclinic form at room temperature, wherein an average concentration of Y₂O₃ in the second ZrO₂ phase is 0.01 to 1 mol %, and the transformation temperature from monoclinic form to cubic form is 900° C.

Japanese Unexamined Patent Application Publication No. 53-128612 discloses an oxygen sensor formed of a zirconia sintered body having a stabilized cubic crystal structure and containing monoclinic crystal structure in a ratio of 5 to 85 wt %.

However, the methods for producing an yttria-stabilized zirconia sintered body disclosed in Japanese Examined Patent Application Publication No. 59-47258 and Japanese Unexamined Patent Application Publication No. 53-128612 are known as solid-state methods and suffer the following disadvantages: a very small amount of tetragonal crystal that is included in the obtained sintered body transforms to monoclinic crystal in the course of hydrothermal deterioration, and as a result, the ceramic is broken.

Australian Patent No. 636696 discloses a zirconia powder for obtaining fritted ceramic parts or coatings by hot spraying, having stable, improved mechanical properties following long-term annealing at high temperature, including in a humid atmosphere and stabilized with the aid of yttrium and cerium oxides, characterized in that it contains between 1 and 3.5 mol % of Y₂O₃ and between 6 and 9 mol % of CeO₂. Patent Document 3 also discloses a process for obtaining the powder, characterized in that the starting material is a zirconia powder with a specific surface area between 4 and 75 m²/g and a particle size of 0.1 μm or less that is impregnated by introducing into a solution of thermally decomposable yttrium and cerium salts, the resulting suspension is filtered, dried and calcined.

However, the zirconia powder of Australian Patent No. 636696 includes a tetragonal zirconia phase exceeding 98%.

### DISCLOSURE OF THE INVENTION

With the foregoing in view, an object of the present invention is to provide an yttria-stabilized zirconia sintered body having optimum properties as an oxygen sensor, i.e., excellent hydrothermal deterioration resistance in addition to excellent thermal shock resistance.

As a result of extensive research to achieve the above object, the present inventors have found a novel yttria-stabilized zirconia sintered body can attain this object, and thereby accomplished the present invention.

The present invention relates to the yttria-stabilized zirconia sintered body shown below.
1. A stabilized zirconia sintered body comprising yttria, wherein
   (1) the sintered body is substantially composed of monoclinic crystals and cubic crystals; and
   (2) an increase of the monoclinic crystals included in the sintered body is 10% by volume or less after the body is subjected to hydrothermal deterioration testing for 5 hours, at 180° C., at 10 atmospheres.
2. An yttria-stabilized zirconia sintered body according to Item 1, wherein the yttria content is in the range of 4 to 7 mol %.
3. An yttria-stabilized zirconia sintered body according to Item 1 or 2, comprising 5 to 40% by volume of the monoclinic crystals.
4. A method for producing an yttria-stabilized zirconia sintered body comprising:
   (1) a first step of mixing while heating a zirconia powder consisting of monoclinic crystals and a solution containing yttrium ions; and
   (2) a second step of calcining the obtained mixture.

### EFFECT OF THE INVENTION

The yttria-stabilized zirconia sintered body of the invention exhibits excellent hydrothermal deterioration resistance in addition to high thermal shock resistance. In more detail, when the yttria-stabilized zirconia sintered body of the invention is subjected to hydrothermal deteriotation testing at 10 atmospheres, at 180° C., for 5 hours, the increase of monoclinic crystals in the sintered body is 10% by volume or less. Such an yttria-stabilized zirconia sintered body is advantageously used as a solid electrolyte, which is used in an oxygen sensor.

According to the method for producing an yttria-stabilized zirconia sintered body of the invention including specific steps, the yttria-stabilized zirconia sintered body obtained exhibits excellent thermal shock resistance and excellent hydrothermal deterioration resistance.

### BEST MODE FOR CARRYING OUT THE INVENTION

The yttria-stabilized zirconia sintered body of the invention and the production process thereof are explained in detail below.

### Yttria-Stabilized Zirconia Sintered Body

The yttria-stabilized zirconia sintered body of the invention substantially comprises monoclinic crystals and cubic crystals, wherein an increase of the monoclinic crystals included in the sintered body is 10% by volume or less after the body is subjected to hydrothermal deterioration testing for 5 hours, at 180° C., at 10 atmospheres.

The zirconia sintered body substantially comprises monoclinic crystals and cubic crystals. Therefore, even when it is subjected to hydrothermal deterioration testing, the monoclinic crystals in the sintered body do not significantly increase and the ceramic is not easily broken.

The zirconia sintered body of the invention substantially composed of monoclinic crystals and cubic crystals may contain tetragonal crystals as long as the effect of the invention is not affected.

After the sintered body is subjected to hydrothermal deterioration testing for 5 hours, at 180° C., at 10 atmospheres, the increase in the monoclinic crystals included in the sintered body is 10% by volume or less, preferably 5% or less and more preferably 2% or less. The sintered body having an increase in monoclinic crystal content exceeding 10% by volume is liable to be damaged when used as an oxygen sensor in an atmosphere including a small amount of water for a long period of time.

The content of yttria in the zirconia sintered body is not particularly limited; however, it is preferably in the range of 4 mol % to 7 mol %.

The monoclinic crystals content in the yttria stabilized sintered body is not particularly limited and can be selected in accordance with usage. In order to produce a material that is required to have high heat-shock resistance, such as for example, a material for an oxygen sensor, setter material and the like, the monoclinic crystals content in the sintered body is preferably 5 to 40% by volume, more preferably 10 to 35% by volume, most preferably 15 to 30% by volume.

When the yttria-stabilized zirconia sintered body contains monoclinic crystals in the range shown above, the sintered body of the invention has a linear thermal expansion coefficient of 9.0×10⁻⁶ or less, and therefore, a sintered body with excellent heat-shock resistance can be obtained.

So long as the desired effect of the invention is obtained, the bulk density of the zirconina sintered body is not particularly limited and can be suitably selected.

### Producing Process of Yttria-Stabilized Zirconia Sintered Body

The method for producing the yttria-stabilized zirconia sintered body of the invention includes (1) a first step of mixing while heating a zirconia powder comprising monoclinic crystals and a solution containing yttrium ions, and (2) a second step of calcining the obtained mixture.

### First Step

In the first step, a monoclinic zirconia powder and a solution containing yttrium ions are mixed.

The monoclinic zirconia powder is not limited, and any commercially available zirconia powder (e.g., trade name: “EP”, “SPZ”, “DK-3CZ”, products of Daiichi Kigenso Kagaku Kogyo Co., Ltd.) can be used.

The BET specific surface area of the zirconia powder is not particularly limited; however, it is preferably in the range of 0.5 to 10 m²/g. When a zirconia powder having a BET specific surface area of less than 0.5 m²/g is immersed into a solution containing yttrium ions, yttrium is easily segregated. A zirconia having a BET specific surface area of more than 10 m²/g adversely affects hydrothermal deterioration resistance due to tetragonal crystal deposition in the sintered body.

The crystallite diameter of the zirconia powder is not particularly limited; however, it is preferably in the range of 300 to 700 Å. When the crystallite diameter is less than 300 Å, tetragonal crystals are deposited in the obtained sintered body, resulting in lowered hydrothermal deterioration resistance. When the crystallite diameter exceeds 700 Å, the zirconia powder is unstable at room temperature.

The particle diameter of zirconia powder is not particularly limited; however, it is preferably in the range of 5 to 20 μm.

The solution containing yttrium ions is not particularly limited. Examples of such solutions include an yttrium chloride solution, an yttrium nitrate solution, an yttrium acetate solution, etc. Among these, the yttrium nitrate solution is preferred in view of the easiness of aftertreatment.

The solvent in the yttrium solution is not particularly limited and examples thereof include water, ether, ethanol, etc.

The concentration of the yttrium solution is not limited; however, it is preferably in the range of 10 to 20% by weight as the oxide equivalent of the yttrium ion. An yttrium solution having a concentration of less than 10% by weight requires a long period of time for the heating process, as explained below. On the other hand, when the yttrium solution has a concentration of more than 20% by weight, yttrium salt may be deposited from solution especially in winter.

During the first step, the zirconia powder and the yttrium solution are mixed while being heated.

The mixing method is not particularly limited. For example, the following method is preferably employed: mixing the zirconia powder impregnated with the yttrium solution and the yttrium solution, and forcibly evaporating the solvent of the solution by heating. A known device, such as a screw feeder including a heating device, can be used as a mixing device.

In the mixing process of the first step, excessive yttrium salt in the yttrium solution is attached to the zirconia powder. Such an embodiment is also included in the present invention.

### Second Step

In the second step, the mixture obtained in the first step is calcined.

The calcination temperature is not particularly limited; however, it is preferably in the range of 1300 to 1600° C., more preferably in the range of 1400 to 1500° C., and most preferably in the range of 1400 to 1450° C. When the calcination temperature is lower than 1300° C., a sintered body having sufficient density may not be obtained. When the calcination temperature exceeds 1600° C., a sintered body substantially free of monoclinic crystals (substantially consisting of cubic crystals) may be obtained.

The calcination time is not particularly limited; however, it is preferably in the range of from 1 hour to 3 hours. When the calcination time is less than 1 hour, a sintered body having insufficient density may be obtained. When the calcination time exceeds 3 hours, a sintered body substantially free of monoclinic crystals may be obtained.

There are no limitations on the calcination atmosphere so far as the yttria-stabilized zirconia sintered body of the invention is obtained. For example, the calcination can be carried out in air, in an oxidizing atmosphere, etc.

In advance of the calcination treatment, the mixture above or the material obtained in a heating process may be precalcined.

Precalcination temperature is not particularly limited; however, it is preferably in the range of 900 to 1300° C., and more preferably in the range of 1000 to 1200° C. There are no particular limitations on the precalcination time; however, about 1 to 3 hours are preferred. With this precalcination treatment, yttria can be more easily dissolved in the zirconia powder.

When a precalcinated body is calcined, the body may be crushed beforehand. The particle size of pulverized material is not particularly limited; however, it is preferable to use a material having a particle size of 1 μm or smaller in order to increase the density of the sintered body.

A device used for pulverization is not particularly limited so far as the device is capable of pulverizing the material into a particle having the desired size. Examples of such a device include known dry types of pulverizer such as vibration mill, ball mill, planetary mill, etc.

During pulverization (dry crushing), it is preferable to add a dispersing agent (e.g. propylene glycol, etc.,) in a ratio of 0.5 to 2% by weight in order to prevent a reduction in crushing efficiency caused by powders adhered to the media or pot used for pulverization.

The pulverized material may be molded as required. Molding pressure is suitably selected in accordance with the required properties of the final products.

### BRIEF DESCRIPTION OF THE DRAWING

FIG. 1 is a graph showing the powder X-ray diffraction results to each yttria-stabilized zirconia sintered body (6.0 mol %) obtained at each calcination temperature.

### EXAMPLES

The following examples are given to illustrate the specific features of the invention. Moreover, the present invention is not limited thereto.

### Example 1

Six kilograms of zirconium oxide with a purity of 99.5% or more (product of Daiichi Kigenso Kagaku Kogyo Co., Ltd.,: “DK-3 CZ”, specific surface area of 1.2 m²/g, crystallite diameter of 520 Å, particle diameter of 14 to 15 μm) having a monoclinic crystals and 3.51 kg of yttrium nitrate aqueous solution (20 wt % in concentration expressed in terms of oxide) were mixed and stirred in a container, which was made of stainless steel. Then, the solution was stirred for 5 hours while heating the bottom of the container at 200° C. The water included in the solution was then completely evaporated off, and the zirconium oxide obtained was impregnated with a yttrium nitrate aqueous solution. The impregnated material obtained was precalcined at 1100° C. in air, for 2 hours to obtain an oxide. Six grams of propylene glycol as a dispersant was added to 600 g of the oxide obtained, in a resin pot having a capacity of 2.4 L. The resultant was dry-crushed using a vibration mill for 10 hours, employing 5 kg of zirconia balls (10 mm in diameter) as grinding media to obtain a powder.

The powder obtained, having a particle size of 0.50 μm and a specific surface area of 6.8 m²/g, was molded into a disk with a hydrostatic press under a pressure of 1.0 t/cm² and retention time of 2 minutes. The molding body was heated at 1400° C. for 2 hours in air to obtain an yttria-stabilized zirconia sintered body. The yttria contents in the yttria-stabilized zirconia sintered body was 6.0 mol %.

### Example 2

Yttria-stabilized zirconia sintered bodies were produced in the same manner as in Example 1, except that the amounts of the additional yttrium nitrate solutions was varied so as to obtain yttria-stabilized zirconia sintered bodies having an yttria content of 5.0 mol %, 5.5 mol %, 6.5 mol %, respectively.

### Example 3

Yttria-stabilized zirconia sintered bodies were obtained in the same manner as in Example 1 or 2 except that the calcination temperature was changed to 1450° C. or 1500° C.

### Test Example 1

The bulk densities of the yttria stabilized zirconia sintered bodies obtained in Examples 1 to 3 were individually measured, according to the Archimedes method. The results are shown in table 1.

### Test Example 2

The monoclinic-cubic ratios of the yttria-stabilized zirconia sintered bodies obtained in Examples 1 to 3 were individually measured, by means of powder X-ray diffraction (XRD). The results are shown in table 1.

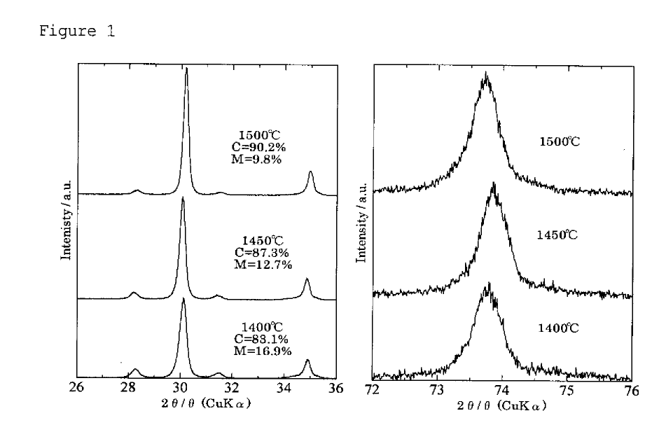

In FIG. 1, the XRD measurement results of yttria-stabilized zirconia sintered bodies (6.0 mol %) obtained at different calcinating temperatures are shown.

Since no peaks (tetragonal) were observed in the T(220) plane in the vicinity of 2θ==74.5° and in the T(004) plane in the vicinity of 2θ=73.5° in FIG. 1, the sintered bodies obtained are recognizable as being composed of cubic and monoclinic crystals. Furthermore, Table 1 shows that the cubic-monoclinic ratio in the sintered body can be controlled by the yttria content and calcination temperature.

TABLE 1

| | | | Cubic | Monoclinic |
|---|---|---|---|---|
| Y₂O₃ | Calcination | Bulk | Crystals | Crystals |
| mol % | Temperature | Density (g/cm³) | Content (%) | Content (%) |
| 5.0 mol % | 1400° C. | 5.76 | 69.2 | 30.8 |
| | 1450° C. | 5.90 | 73.6 | 26.4 |
| | 1500° C. | 5.96 | 76.4 | 23.6 |
| 5.5 mol % | 1400° C. | 5.86 | 76.5 | 23.5 |
| | 1450° C. | 5.93 | 82.8 | 17.2 |
| | 1500° C. | 5.97 | 87.6 | 12.4 |
| 6.0 mol % | 1400° C. | 5.89 | 83.1 | 16.9 |
| | 1450° C. | 5.94 | 87.3 | 12.7 |
| | 1500° C. | 5.96 | 90.2 | 9.8 |
| 6.5 mol % | 1400° C. | 5.86 | 82.7 | 17.3 |
| | 1450° C. | 5.93 | 88.9 | 11.1 |
| | 1500° C. | 5.96 | 92.4 | 7.6 |

### Test Example 3

The linear thermal expansion coefficient of the yttria-stabilized zirconia sintered body obtained in Example 1 was measured: The measurement conditions are shown below:
Temperature: 25-1200° C.
Heating rate: 5° C./minute
Weight Load: 5 kgf
Atmosphere: inert gas
Standard Sample: alumina
Device: “TMA 8140” product of Rigaku Denki Co., Ltd., (differential expansion method)
The linear coefficient of thermal expansion of the sintered body was 8.7×10⁻⁶.

This result shows that an yttria-stabilized zirconia sintered body having a crystal structure with monoclinic crystals has a low linear thermal expansion coefficient. Namely, ceramics having high thermal shock resistance can be obtained by including a specific amount of monoclinic crystals in the sintered body.

### Test Example 4

The yttria-stabilized zirconia sintered body obtained in Example 1 was subjected to hydrothermal deterioration testing. First, the surface of the sintered body was mirror polished using a diamond paste (diamond particle size=3.0 μm). The polished surface was inspected using XRD to obtain a monoclinic (M)-cubic (C) crystal ratio. The hydrothermal deterioration testing was carried out using an autoclave (product of Taiatsu garasu kougyou Co., Ltd.,: “TEM-V”). In greater detail, the sintered body was placed in a pressure resistant container (800 mL) with the polished surface facing up. 500 mL of pure water was slowly poured into the container so as not to move the sintered body. Then, the sintered body was subjected to hydrothermal deterioration testing for 5 hours at 180° C., at 10 atmospheres, and the increase in monoclinic crystals was determined. The results are shown in Table 2.

Referring to the peaks of the X-ray diffraction chart, the monoclinic-cubic crystals ratio was calculated using the following formula.

Cubic crystals %=C(101)/{M(−111)+C(101)+M(111)}×100 Monoclinic crystals %=M(−111)+M(111)/{M(−111)+C(101)+M(111)}×100

TABLE 2

| | Monoclinic Crystals Increase |
|---|---|
| | (Volume %) |
| Sample 1 | 0.4 |
| Sample 2 | 1.0 |
| Sample 3 | 0.6 |
| Sample 4 | 0.7 |
| Sample 5 | 0.6 |

Table 2 indicates that the monoclinic crystal content has not essentially increased after hydrothermal deterioration testing. It is clear that the sample has extremely high resistance to hydrothermal degradation.

1. A stabilized zirconia sintered body comprising yttria, wherein
(1) the sintered body is substantially composed of monoclinic crystals and cubic crystals; and
(2) the sintered body having hydrothermal deterioration resistance such that an increase of the monoclinic crystals included in the sintered body is 10% by volume or less after the body is subjected to hydrothermal deterioration testing for 5 hours, at 180° C., at 10 atmospheres;
wherein the sintered body has the yttria content in the range of 4 to 7 mol%, and comprises 5 to 40% by volume of the monoclinic crystals.

2. (canceled)

3. (canceled)

4. A method for producing an yttria-stabilized zirconia sintered body comprising:
(1) a first step of mixing while heating a zirconia powder comprising monoclinic crystals and a solution containing yttrium ions; and
(2) a second step of calcining the obtained mixture.

5. An yttria-stabilized zirconia sintered body according to claim 1, wherein the sintered body is composed of monoclinic crystals and cubic crystals.
